(19) United States
(12) Patent Application Publication
(10) Pub. No.: US 2011/0209051 A1
(43) Pub. Date: Aug. 25, 2011

(54) DOCUMENT BROWSING SYSTEM AND DOCUMENT CONVERSION SERVER

(75) Inventor: Yoshiko SHIIMORI, Tokyo (JP)

(73) Assignee: FUJIFILM Corporation, Tokyo (JP)

(21) Appl. No.: 12/978,121

(22) Filed: Dec. 23, 2010

(30) Foreign Application Priority Data
Feb. 24, 2010 (JP) JP 2010-039055

(51) Int. Cl. G06F 17/24

(52) U.S. Cl. 715/255

(57) ABSTRACT

A document conversion server includes: a conversion information management device configured to manage conversion information for converting document data into image data for browsing with respect to each model type of the mobile terminal; a receiving device configured to receive the model type information of the mobile terminal and the document data from the web server; a document data conversion device configured to read the corresponding conversion information from the conversion information management device on the basis of the received model type information of the mobile terminal, and to convert the received document data into the image data for browsing for the mobile terminal on the basis of the read conversion information; and an image data transmitting device configured to transmit the converted image data for browsing to the mobile terminal.

### BACKGROUND OF THE INVENTION

1. Field of the Invention

The presently disclosed subject matter relates to a document browsing system and a document conversion server, and particularly to a technique that allows a mobile terminal to browse document data.

2. Description of the Related Art

Conventionally, as with an art described in Japanese Patent Application Laid-Open No. 2002-351736, there are a lot of techniques that optimize a HTML (Hypertext Markup Language) document for a mobile phone when the HTML document is browsed by the mobile phone.

For example, Japanese Patent Application Laid-Open No. 2002-351736 describes a technique that adds link information for indicating a link to another page to each page of divided pieces of document data and assigns thereto a headline of another page, a leading word of another page or a word representing another page. The technique of Japanese Patent Application Laid-Open No. 2002-351736 allows a user to easily browse the document data even when the document data is divided.

Further, it has become popular to set document links to documents, such as of Microsoft Office Word document and PDF (Portable Document Format) document, in a HTML document and thereby browse and edit the documents, such as of Word and PDF, directly on a browser of a personal computer (PC).

### SUMMARY OF THE INVENTION

However, there is a problem that mobile terminals such as mobile phones in which software necessary to browse and edit documents such as of Word and PDF are not installed or cannot be installed are incapable of browsing these documents through document links in a HTML document.

The art described in Japanese Patent Application Laid-Open No. 2002-351736 does not consider document links in an HTML document. Accordingly, even after optimization for mobile phones, the mobile phones are incapable of browsing documents, such as of Word and PDF through the document links in the HTML document.

The presently disclosed subject matter is made in view of such situations. It is an object of the presently disclosed subject matter to provide a document browsing system and a document conversion server that allow a mobile terminal such as a mobile phone incapable of opening documents such as of Word or PDF to browse documents in various formats.

In order to attain the object, a first aspect according to the presently disclosed subject matter provides a document browsing system including a web server and a document conversion server, and said document browsing system configured to allow a mobile terminal to browse document data in the web server, wherein the web server includes: a document data management device configured to manage the document data; an information acquisition device configured, when the mobile terminal requests browsing of the document data managed by the document data management device, to acquire model type information of the mobile terminal, and to acquire from the document data management device the document data requested for browsing; and a transmitting device configured to transmit the model type information of the mobile terminal and the document data, having been received, to the document conversion server, and the document conversion server includes: a conversion information management device configured to manage conversion information for converting the document data into image data for browsing with respect to each model type of the mobile terminal; a receiving device configured to receive the model type information of the mobile terminal and the document data from the web server; a document data conversion device configured to read the corresponding conversion information from the conversion information management device on the basis of the received model type information of the mobile terminal, and to convert the received document data into the image data for browsing for the mobile terminal on the basis of the read conversion information; and an image data transmitting device configured to transmit the converted image data for browsing to the mobile terminal.

Not many mobile terminals, such as mobile phones, are capable of opening documents, such as of Word and PDF. However, the majority of the mobile terminals have a function of browsing at least one type of images, such as JPEG (Joint Photographic Experts Group) images, GIF (Graphics Interchange Format) images, PNG (Portable Network Graphics) images and BMP (bitmap) images.

Thus, in the first aspect, the document conversion server converts the document data into the image data for browsing and transmits the converted data to the mobile terminal. Accordingly, the document to be browsed can be browsed as the image. More specifically, when browsing of the document data in the web server is requested, the model type information of the mobile terminal is acquired, the document data requested for browsing is acquired from the document data management device, and the information is transmitted to the document conversion server. The document conversion server reads the conversion information managed with respect to each model type on the basis of the received model type information of the mobile terminal, converts the document data into the image data for browsing optimized for the mobile terminal on the basis of the conversion information, and transmits the converted data to the mobile terminal. Accordingly, browsing is enabled to be performed, even with the mobile terminal which does not have a function of opening the document, and with respect to document data in any format.

A second aspect according to the presently disclosed subject matter provides a document browsing system including a web server and a document conversion server, and the document browsing system configured to allow a mobile terminal to browse document data in the web server, wherein the web server includes: a document data management device configured to manage the document data in association with identification information of the document data; an information acquisition device configured, when the mobile terminal requests browsing of the document data managed by the document data management device, to acquire model type information of the mobile terminal and the identification information of the document data requested for browsing; and a transmitting device configured to transmit the model type information of the mobile terminal and the identification information of the document data, having been received, to the document conversion server, and the document conversion server includes: a conversion information management device configured to manage conversion information for converting the document data into image data for browsing with respect to each model type of the mobile terminal; a document data conversion device configured to convert the document data into the image data for browsing, and the document data conversion device configured to convert the document data into the image data for browsing corresponding to each mobile terminal on the basis of the conversion information managed by the conversion information management device with respect to each model type of the mobile terminal; an image data management device configured to manage the converted image data for browsing in association with the model type information of the mobile terminal and the identification information of the document data; a receiving device configured, when the mobile terminal requests browsing of the document data managed by the web server, to receive the model type information of the mobile terminal and the identification information of the document data via the web server; and an image data transmitting device configured to read the corresponding image data for browsing from the image data management device on the basis of the model type information of the mobile terminal and the identification information of the document data, having been received, and to transmit the read data to the mobile terminal.

The document conversion server of the first aspect acquires the document data from the web server every time the browsing of the document data is requested by the mobile terminal, and generates the image data for browsing from the document data. On the other hand, the document conversion server of the second aspect preliminarily creates and stores pieces of image data for browsing of respective pieces of document data with respect to each model type of the mobile terminal. When the mobile terminal requests browsing of the document data, the identification information of document data requested for browsing by the web server and the model type information of the mobile terminal are acquired, and the corresponding image data for browsing is read from the image data management device on the basis of the information.

A third aspect of the presently disclosed subject matter provides a document browsing system according to the first or second aspects, wherein the web server further includes a web page providing device configured to provide a web page which is capable of being browsed by the mobile terminal, and the web page including the identification information of the document data managed by the document data management device, and the information acquisition device, when the mobile terminal requests browsing of the document data managed by the document data management device via the web page, acquires the model type information of the mobile terminal and the identification information of the document data.

A fourth aspect according to the presently disclosed subject matter provides a document browsing system including a web server and a document conversion server, and the document browsing system configured to allow a mobile terminal to browse document data in the web server, wherein the web server includes: a document data management device configured to manage the document data in association with identification information of the document data; and a web page providing device configured to provide a web page which is capable of being browsed by the mobile terminal and includes the identification information of the document data managed by the document data management device and connection information to the document conversion server, and the document conversion server includes: a conversion information management device configured to manage conversion information for converting the document data into image data for browsing with respect to each model type of the mobile terminal; a receiving device configured, when the mobile terminal requests browsing of the document data managed by the document data management device of the web server via the web page, to receive the model type information of the mobile terminal, and to receive the identification information of the document data having been requested for browsing; a document data acquisition device configured to acquire the corresponding document data from the document data management device of the web server on the basis of the identification information of the received document data; a document data conversion device configured to read the corresponding conversion information from the conversion information management device on the basis of the received model type information of the mobile terminal, and to convert the acquired document data into the image data for browsing for the mobile terminal on the basis of the read conversion information; and an image data transmitting device configured to transmit the converted image data for browsing to the mobile terminal.

In the fourth aspect, the identification information of the document data and the connection information to the document conversion server are embedded in the web page, such as a HTML document, provided by the web server. When the mobile terminal requests for browsing of the document data in the web page, the request of browsing including the identification information of the document data is directly transmitted from the mobile terminal to the document conversion server. The document conversion server acquires the corresponding document data from the web server on the basis of the identification information of the document data received from the mobile terminal. Subsequent processes are as with the first aspect.

A fifth aspect of the presently disclosed subject matter provides a document browsing system according to any one of the first to fourth aspects, wherein the document conversion server further includes: a document browsing application management device configured to manage a document browsing application with respect to each model type of the mobile terminal; and a document browsing application transmitting device configured to read the corresponding document browsing application on the basis of the received model type information of the mobile terminal from the document browsing application management device, and to transmit the application to the mobile terminal, and the image data transmitting device transmits the image data for browsing requested for browsing by the document browsing application, responsive to browsing operation at the mobile terminal having received the read document browsing application.

The document browsing applications, which vary according to carriers of the mobile terminals, provides the mobile terminal having requested the document browsing application corresponding to the mobile terminal with this document browsing application on the basis of the model type information of the mobile terminal. This document browsing application is downloaded to the mobile terminal, thereby enabling the mobile terminal to perform document browsing operations (page forwarding, zoom in/out, turning, etc.).

A sixth aspect of the presently disclosed subject matter provides a document conversion server including: a conversion information management device configured to manage conversion information for converting document data into image data for browsing with respect to each model type of the mobile terminal; a receiving device configured to receive the model type information of the mobile terminal and the document data from the web server; a document data conversion device configured to read the corresponding conversion information from the conversion information management device on the basis of the received model type information of the mobile terminal, and to convert the received document data into the image data for browsing for the mobile terminal on the basis of the read conversion information; and an image data transmitting device configured to transmit the converted image data for browsing to the mobile terminal.

A seventh aspect of the presently disclosed subject matter provides a document conversion server including: a conversion information management device configured to manage conversion information for converting document data into image data for browsing with respect to each model type of the mobile terminal; a document data conversion device configured to convert the document data into the image data for browsing for a mobile terminal, the image data for browsing corresponding to each mobile terminal, on the basis of the conversion information managed by the conversion information management device with respect to each model type of the mobile terminal; an image data management device configured to manage the converted image data for browsing in association with the model type information of the mobile terminal and the identification information of the document data; a receiving device configured, when the mobile terminal requests browsing of the document data managed by the web server, to receive the model type information of the mobile terminal and the identification information of the document data via the web server; and an image data transmitting device configured to read the corresponding image data for browsing from the image data management device on the basis of the model type information of the mobile terminal and the identification information of the document data, having been received, and to transmit the read data to the mobile terminal.

An eighth aspect of the presently disclosed subject matter provides a document conversion server including: a conversion information management device configured to manage conversion information for converting document data into image data for browsing with respect to each model type of a mobile terminal; a receiving device configured, when the mobile terminal requests browsing of the document data managed by a web server via a predetermined web page, to receive the model type information of the mobile terminal, and to receive identification information of the document data having been requested for browsing; a document data acquisition device configured to acquire the corresponding document data for browsing from the web server managing the document data, on the basis of the identification information of the received document data; a document data conversion device configured to read the corresponding conversion information from the conversion information management device on the basis of the received model type information of the mobile terminal, and to convert the acquired document data into the image data for browsing for the mobile terminal on the basis of the read conversion information; and an image data transmitting device configured to transmit the converted image data for browsing to the mobile terminal.

The document conversion servers according to the sixth to eighth aspects correspond to the document conversion servers in the first to third aspects (the document browsing systems), respectively.

A ninth aspect of the presently disclosed subject matter provides a document conversion server according to any one of the sixth to eighth aspects, further including: a document browsing application management device configured to manage a document browsing application with respect to each model type of the mobile terminal; and a document browsing application transmitting device configured to read the corresponding document browsing application from the document browsing application management device on the basis of the received model type information of the mobile terminal, and to transmit the application to the mobile terminal, wherein the image data transmitting device transmits the image data for browsing requested for browsing by the document browsing application, responsive to browsing operation at the mobile terminal having received the document browsing application.

According to the presently disclosed subject matter, when the mobile terminal such as a mobile phone requests browsing of the document data, the document data requested for browsing is converted into the image data for browsing optimized for the mobile terminal, and the data is transmitted. Therefore, the mobile terminal incapable of opening documents, such as of Word and PDF, is allowed to browse documents in various formats.

### BRIEF DESCRIPTION OF THE DRAWINGS

FIG. 1 is a diagram illustrating an example of the entire configuration of a document browsing system according to the presently disclosed subject matter.

FIG. 2 is a diagrammatic table of illustrating details of processes corresponding to respective numerals illustrated in FIG. 1;

FIG. 3 is a flowchart illustrating a first embodiment of the document browsing system according to the presently disclosed subject matter;

FIG. 4 is a diagram illustrating a database configuration of a document conversion server; and

FIG. 5 is a flowchart illustrating a third embodiment of the document browsing system according to the presently disclosed subject matter.

### DETAILED DESCRIPTION OF THE PREFERRED EMBODIMENTS

Embodiments of a document browsing system and a document conversion server according to the presently disclosed subject matter will hereinafter be described with reference to the accompanying drawings.

### First Embodiment

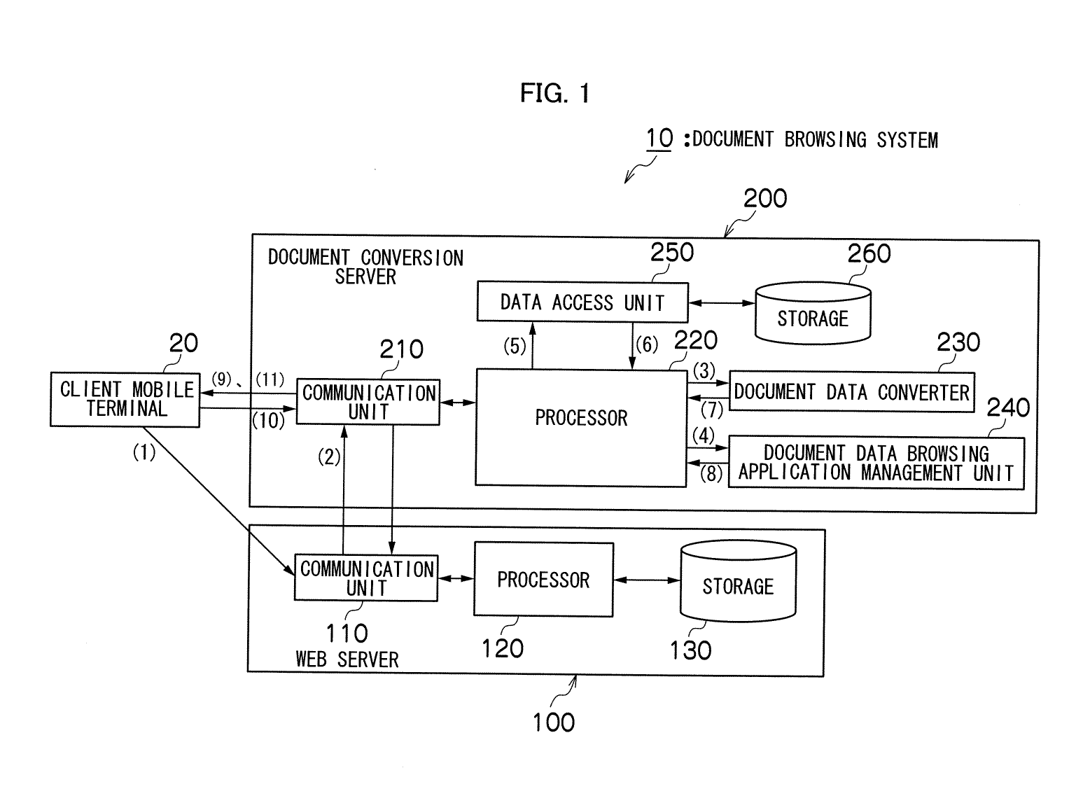

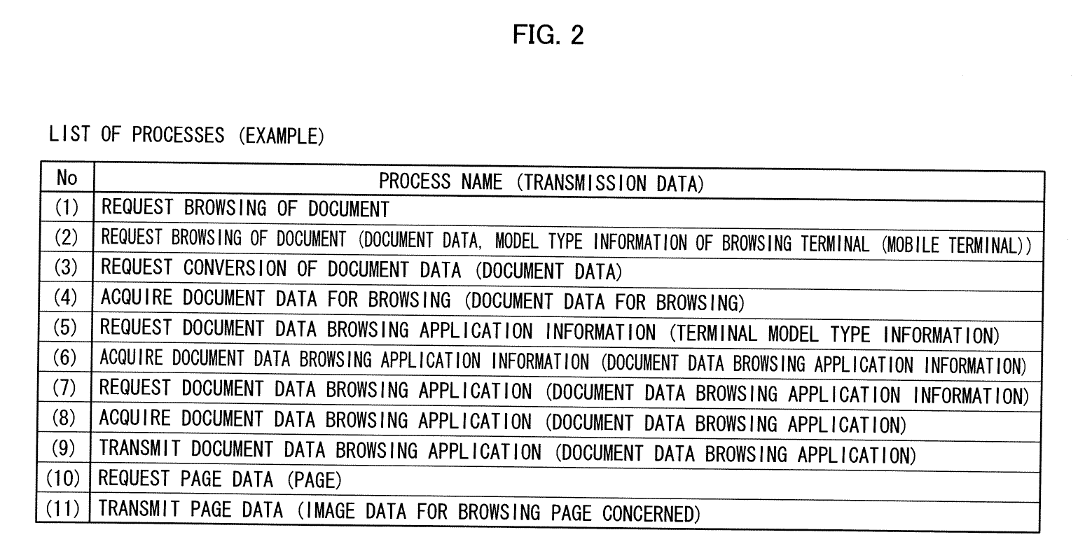

FIG. 1 is a diagram illustrating an example of the entire configuration of a document browsing system 10 of this embodiment. FIG. 2 is a diagrammatic table of illustrating details of processes corresponding to respective numerals illustrated in FIG. 1.

As illustrated in FIG. 1, the document browsing system 10 includes a web server 100 and a document conversion server 200 which typically exist in the Internet, and the document browsing system 10 is capable of communicating with a mobile terminal 20, such as a mobile phone, used by a user, via a mobile network and the Internet.

The web server 100 includes a communication unit 110, a processor 120 and a storage 130. The communication unit 110 is a communication section that communicates according to HTTP (Hypertext Transfer Protocol). The storage 130 is a section that stores and manages information including HTML documents, document files such as of Word and PDF, and image files.

The processor 120 is for overall control of elements in the web server 100, and provides HTML documents (web page) which are for mobile phones and HTML documents which are for PCs via the communication unit 110. Further, the processor 120 provides various pieces of information managed in the storage 130 (browsing and downloading), and also transmits necessary information such as model type information of the mobile terminal 20, as will described later, responsive to a request from the mobile terminal 20 or the document conversion server 200.

The document conversion server 200 includes a communication unit 210, a processor 220, a document data converter 230, a document data browsing application management unit 240, a data access unit 250 and a storage 260.

The communication unit 210 is a section for communication with the mobile terminal 20 and web server 100 according to HTTP communication. In this embodiment, the model type information of the mobile terminal 20 of the opposite party and the document data requested for browsing by the mobile terminal 20 are received from the web server 100. Further, image data for browsing, which will be described later, is transmitted to the mobile terminal 20.

The storage 260 is a section that stores and manages conversion information for converting document data into image data for browsing with respect to each model type of the mobile terminal and stores the converted image data for browsing.

The document data converter 230 is a section that converts the document data of the document files, such as of Word and PDF, acquired from the web server 100 into image data (image data for browsing), such as of JPEG, GIF, PNG and BMP. The document data converter 230 converts the document data into image data for browsing optimized for the mobile terminal 20 according to the model type of the mobile terminal 20 of the opposite party requesting browsing.

The processor 220, which is for overall control of elements of the document conversion server 200, acquires the model type information of the mobile terminal 20 and the document data from the web server 100 via the communication unit 210, and transmits the converted image data for browsing and the like to the mobile terminal 20 via the communication unit 210.

In FIG. 1, only one mobile terminal 20 and one web server 100 are illustrated. However, a plurality thereof may exist, each of which is capable of separately communicating with the document conversion server 200.

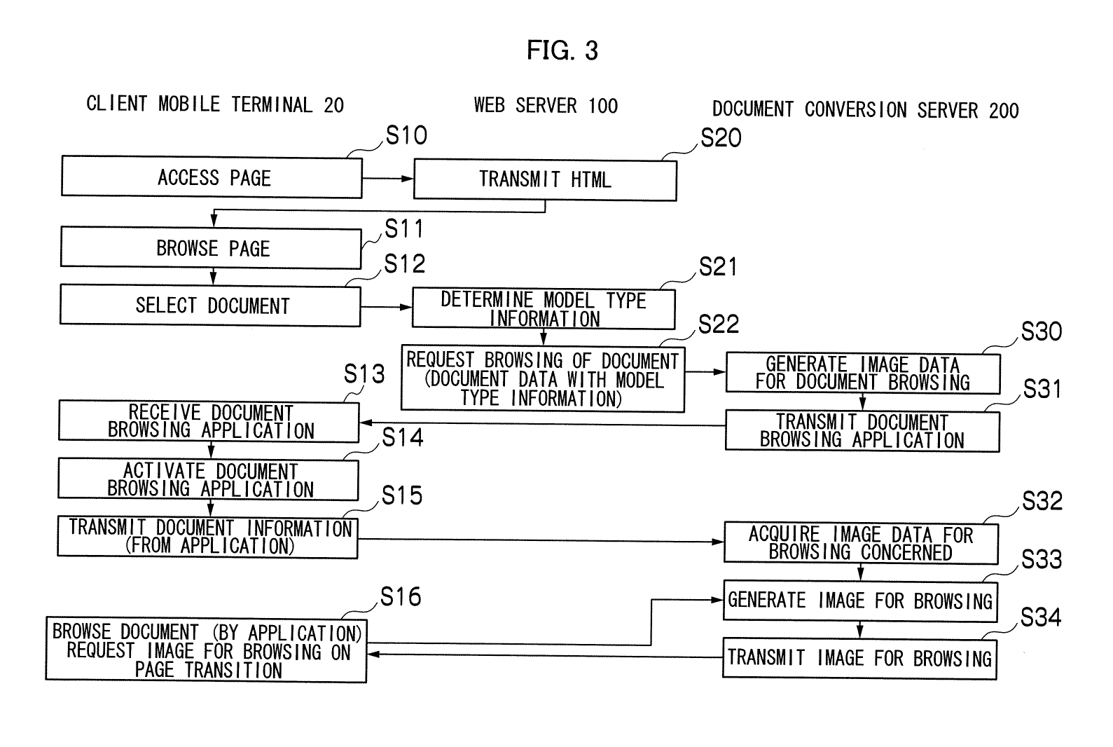

Next, an operation of the document browsing system 10 thus configured will be described according to a flowchart illustrated in FIG. 3.

The user issues a request for browsing a desired HTML document (web page) using an operation unit, which is not illustrated, of the mobile terminal 20 (step S10). The web server 100 transmits the HTML document requested for browsing to the mobile terminal 20 (step S20).

The user browses the HTML document transmitted from the web server 100, using a browser in the mobile terminal 20 (step S11). Here, when a document link in the HTML document browsed by the user is clicked (document-selected) (step S12), a request for browsing a document embedded in the document link is transmitted to the web server 100. The request for browsing the document includes identification information of the document file to be acquired.

The web server 100 having received the request for browsing the document determines and acquires the model type information of the originating mobile terminal 20 (step S21), reads a corresponding document file from the storage 130 on the basis of the identification information of the document file, and transmits the request for browsing the document, which includes the document file and the model type information, to the document conversion server 200 (step S22). The request for browsing the document transmitted to the document conversion server 200 includes the originating address of the mobile terminal 20 requesting the browsing.

The document conversion server 200 having received the request for browsing the document generates image data for browsing optimized for browsing at the mobile terminal 20 from the document data of the document file on which the request for browsing has been issued (step S30).

More specifically, the processor 220 of the document conversion server 200 reads conversion information for converting the document data into the image data for browsing from the storage 260 via the data access unit 250 on the basis of the model type information of the mobile terminal 20 having been acquired via the communication unit 210, and passes the request for converting document data including the document data together with the conversion information to the document data converter 230. The document data converter 230 converts the document data into the image data for browsing optimized for the mobile terminal responsive to the request for converting document data. Note that, depending on the model type of the mobile terminal, types of reproducible image data (JPEG, GIF, PNG, BMP, etc.) vary, and types of carriers of the mobile terminals, screen sizes of the mobile terminal, capacity limitations, processing capability and the like vary. Use of the conversion information supporting the model type of the mobile terminal requesting browsing allows the image data for browsing optimized for the mobile terminal to be generated.

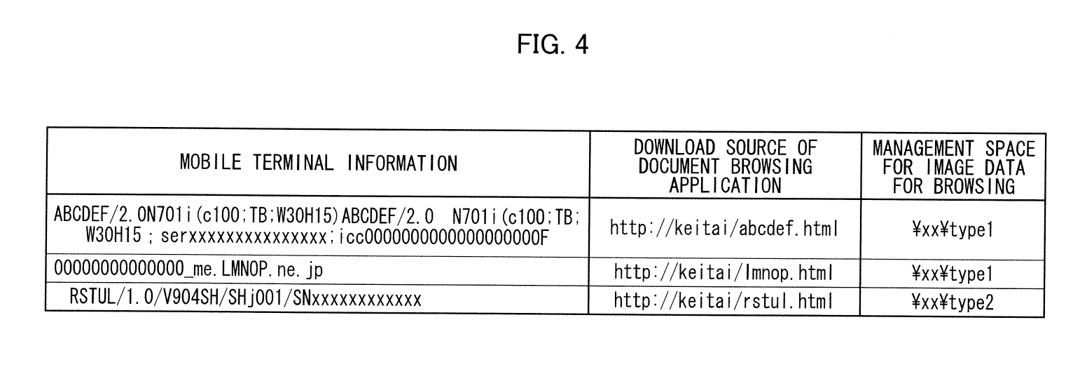

The image data for browsing generated as described above is stored in the storage 260 via the data access unit 250. Here, as illustrated in FIG. 4, the image data for browsing is stored in association with the model type information of the mobile terminal, in a management space for the data for browsing in a database. The image data for browsing is thus stored in the management space corresponding to the model type of the mobile terminal. Accordingly, when the same model type of the mobile terminal requests browsing the same document, the image data for browsing stored in the management space can be used without generation of the image for browsing.

As illustrated in FIG. 4, download sources of applications for browsing documents, and management spaces for image data for browsing are managed, in association with the model type information of mobile phones, in the storage 260. The processor 220 acquires the document browsing application for the mobile terminal, on the basis of information of the download source of the document browsing application corresponding to the model type information of the mobile terminal. This is because the document browsing applications vary with respect to the carriers of the mobile terminal. The processor 220 generates control information of the read document browsing application for browsing the document concerned.

The processor 220 transmits the application control information and document information (information of the management space of the image data for browsing) indicating the image data for browsing, together with the document browsing application, to the mobile terminal 20 (step S31).

The mobile terminal 20 receives the document browsing application (step S13), and activates the document browsing application immediately after the reception (step S14). Further, the mobile terminal 20 transmits the document information added to the application from the activated document browsing application to the document conversion server 200, and requests image data for browsing (step S15).

The document conversion server 200 having received the document information acquires the image data concerned for browsing from the storage 260 (step S32).

The document conversion server 24 generates image data for browsing which is for allowing the mobile terminal 20 to display a first page of the document data, from the acquired image data for browsing (step S33), and transmits the first page of the image data for browsing to the mobile terminal 20 (step S34).

The mobile terminal 20 having received the image data for browsing displays the image data for browsing using the document browsing application on a display unit (not illustrated) (step S16). The mobile terminal 20 is incapable of displaying documents of document files, such as Word files and PDF files. However, since image data for browsing (JPEG image etc.) in a displayable format is transmitted thereto, the mobile terminal 20 is capable of displaying the data on the display unit using the document browsing application.

Subsequently, when the document browsing application requests the image data for browsing responsive to document browsing operations (page forwarding, zoom in/out, scroll, turning, etc.) on the mobile terminal 20 by the user, the document conversion server 200 generates the corresponding image data for browsing and transmits the data to the mobile terminal 20 again (steps S33 and S34).

Because the screen on the display unit of the mobile terminal 20 is small, there is a case where characters cannot be read even when the entire one page of a document is displayed. In this case, if the mobile terminal 20 performs a zoom in process on the image data for browsing, the image quality of the image data for browsing is reduced. Accordingly, when the document conversion server 200 receives a request for browsing, such as the zoom in, from the document browsing application by the document browsing operation on the mobile terminal 20, the document conversion server 200 generates image data for browsing corresponding to the request for browsing and transmits the generated data to the mobile terminal 20.

Thus, only image data for browsing necessary for display on one screen at the mobile terminal 20 is transmitted and received. This manner allows the amount of communication of image data for browsing to be decreased, and allows the load on the document conversion server 200 to be reduced. Note that the document conversion server 24 may aggregate detailed image data for browsing for the entire pages of the document file and transmit the aggregated data to the mobile terminal 20.

The document browsing application is configured so as to be capable of managing and browsing the image data for browsing on a page-by-page basis. The user can browse the image data for browsing on a page-by-page basis according to the page sequence as with browsing the document file on a PC.

Further, the document browsing application includes a function of preventing browsed images from being stored in the mobile terminal 20, thereby maintaining security on the browsed images. More specifically, the browsed image stored in a memory for display is erased when the browse (display) is finished, and does not remain in the mobile terminal 20. In particular, this configuration is effective when document data in a web server in an in-house intranet is browsed. When document data in a web server in the Internet that anyone can access is browsed, there is no need to consider security. Accordingly, the data is not necessarily erased from the memory.

Even in a case where document links to Word files and PDF files inaccessible from the mobile terminal thus exist in the HTML document, when the document links are selected, the document files are converted into the images and transmitted to the mobile terminal, thereby enabling the documents to be browsed as with situations where the document files are opened in the mobile terminal.

In this embodiment, the web server 100 provides the HTML document (web page) for mobile terminals and the HTML document for PCs. However, without limitation thereto, only the HTML document for PCs may be provided, the web server 100 may determine whether the terminal requesting document browsing at the HTML document is the mobile terminal or the PC and switch subsequent processes. In this embodiment, the case where the requested web page is the HTML document is described. However, the presently disclosed subject matter can be applied to cases where the page is a content file, such as XML (Extensible Markup Language) and SML (Standard Meta Language).

### Second Embodiment

A document browsing system of a second embodiment is analogous in configurations of apparatuses to the system of the first embodiment illustrated in FIG. 1. However, processing procedures thereof are different.

More specifically, in the first embodiment, when the mobile terminal 20 requests document browsing, the web server 100 transmits the document file (document file accompanied by the model type information) to the document conversion server 200 every time of the request. However, in the document browsing system of the second embodiment, the web server 100 preliminarily transmits the document file managed by the web server 100 to the document conversion server 200. The document conversion server 200 converts each piece of document data of the received document files into pieces of image data for browsing for the respective model types of the mobile terminals, associates these pieces of image data for browsing with the model type information of the mobile terminals and with the identification information of the document file, and stores and manages the associated data in the storage 260.

When document browsing is requested by the mobile terminal 20, the web server 100 transmits the model type information of the mobile terminal 20 and the identification information of the document file to the document conversion server 200. The document conversion server 200 reads the corresponding image data for browsing from the storage 260, on the basis of the model type information of the mobile terminal 20 and the identification information of the document file, having been received. The other processes are performed as with the first embodiment.

### Third Embodiment

A document browsing system of a third embodiment is analogous in configurations of apparatuses to the system of the first embodiment illustrated in FIG. 1. However, processing procedures thereof are different.

The web server 100 of the document browsing system of the third embodiment provides HTML documents for mobile terminals and HTML documents for PCs. Connection information (URL: Uniform Resource Locator) for jumping to the document conversion server 200 is embedded in document links in the HTML documents for mobile terminals.

Accordingly, when document browsing is requested by the mobile terminal 20, the jump to the document conversion server 200 is directly performed. The document conversion server 200 acquires the model type information of the mobile terminal, the identification information of the document file, originating address and the like from the mobile terminal 20. The document conversion server 200 downloads the corresponding document file from the web server 100 on the basis of the identification information of the document file.

Processes, such as the generation of image data for browsing after downloading of the document file and transmission to the mobile terminal 20, are performed as with the first embodiment.

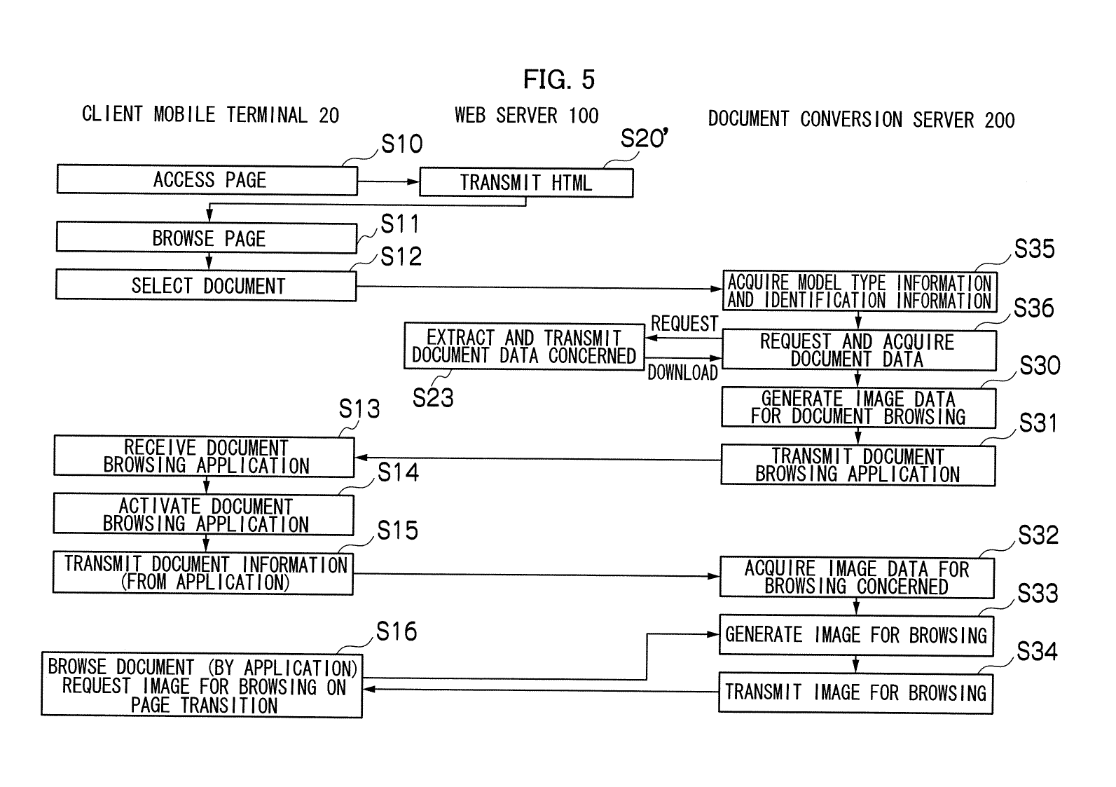

FIG. 5 is a flowchart illustrating the document browsing system of the third embodiment. Elements common to the first embodiment illustrated in FIG. 3 are assigned with the same step numerals. The detailed description thereof is omitted.

The web server 100 transmits a HTML document requested for browsing to the mobile terminal 20. As described above, the connection information (URL) for jumping to the document conversion server 200 is embedded in the document links in the HTML documents for mobile terminals (step S20′).

When the document link in the HTML document browsed by the user is clicked (step S12), a jump to the document conversion server 200 is performed by the URL embedded in the document link, and the request for browsing the document (including the model type information) is directly transmitted to the document conversion server 200. The request for browsing the document includes the identification information of the document file to be acquired.

The document conversion server 200 having received the request for browsing the document acquires the model type information of the originating mobile terminal 20 and the identification information of the document file on which browsing is requested (step S35). Subsequently, the document conversion server 200 requests the corresponding document file from the web server 100 on the basis of the identification information of the document file (step S36). The web server 100 extracts the requested document file from the storage 130, and transmits the file to the document conversion server 200 (step S23).

The document conversion server 200 having downloaded the document file generates image data for browsing optimized for browsing at the mobile terminal 20, from the document data of the document file (step S30).

Subsequent processes are performed as with the first embodiment. The document conversion server 200 transmits the image data for browsing optimized for the mobile terminal 20.

In this embodiment, the web server 100 and the document conversion server 200 are different servers separated from each other. However, both servers may be integrated.

The presently disclosed subject matter is not limited to the aforementioned embodiments. Needless to say, various modifications can be made instead within an extent without departing from the spirit of the presently disclosed subject matter.

What is claimed is:

1. A document browsing system comprising a web server and a document conversion server, and said document browsing system configured to allow a mobile terminal to browse document data in the web server,
wherein the web server comprises:
a document data management device configured to manage the document data;
an information acquisition device configured, when the mobile terminal requests browsing of the document data managed by the document data management device, to acquire model type information of the mobile terminal, and to acquire from the document data management device the document data requested for browsing; and
a transmitting device configured to transmit the model type information of the mobile terminal and the document data, having been received, to the document conversion server, and
the document conversion server comprises:
a conversion information management device configured to manage conversion information for converting the document data into image data for browsing with respect to each model type of the mobile terminal;
a receiving device configured to receive the model type information of the mobile terminal and the document data from the web server;
a document data conversion device configured to read the corresponding conversion information from the conversion information management device on the basis of the received model type information of the mobile terminal, and to convert the received document data into the image data for browsing for the mobile terminal on the basis of the read conversion information; and
an image data transmitting device configured to transmit the converted image data for browsing to the mobile terminal.

2. A document browsing system comprising a web server and a document conversion server, and the document browsing system configured to allow a mobile terminal to browse document data in the web server,
wherein the web server comprises:
a document data management device configured to manage the document data in association with identification information of the document data;
an information acquisition device configured, when the mobile terminal requests browsing of the document data managed by the document data management device, to acquire model type information of the mobile terminal and the identification information of the document data requested for browsing; and
a transmitting device configured to transmit the model type information of the mobile terminal and the identification information of the document data, having been received, to the document conversion server, and
the document conversion server comprises:
a conversion information management device configured to manage conversion information for converting the document data into image data for browsing with respect to each model type of the mobile terminal;
a document data conversion device configured to convert the document data into the image data for browsing, and the document data conversion device configured to convert the document data into the image data for browsing corresponding to each mobile terminal on the basis of the conversion information managed by the conversion information management device with respect to each model type of the mobile terminal;
an image data management device configured to manage the converted image data for browsing in association with the model type information of the mobile terminal and the identification information of the document data;
a receiving device configured, when the mobile terminal requests browsing of the document data managed by the web server, to receive the model type information of the mobile terminal and the identification information of the document data via the web server; and
an image data transmitting device configured to read the corresponding image data for browsing from the image data management device on the basis of the model type information of the mobile terminal and the identification information of the document data, having been received, and to transmit the read data to the mobile terminal.

3. The document browsing system according to claim 1, wherein
the web server further comprises a web page providing device configured to provide a web page which is capable of being browsed by the mobile terminal, and the web page including the identification information of the document data managed by the document data management device, and
the information acquisition device, when the mobile terminal requests browsing of the document data managed by the document data management device via the web page, acquires the model type information of the mobile terminal and the identification information of the document data.

4. A document browsing system comprising a web server and a document conversion server, and the document browsing system configured to allow a mobile terminal to browse document data in the web server,
wherein the web server comprises:
a document data management device configured to manage the document data in association with identification information of the document data; and
a web page providing device configured to provide a web page which is capable of being browsed by the mobile terminal and includes the identification information of the document data managed by the document data management device and connection information to the document conversion server, and
the document conversion server comprises:
a conversion information management device configured to manage conversion information for converting the document data into image data for browsing with respect to each model type of the mobile terminal;
a receiving device configured, when the mobile terminal requests browsing of the document data managed by the document data management device of the web server via the web page, to receive the model type information of the mobile terminal, and to receive the identification information of the document data having been requested for browsing;
a document data acquisition device configured to acquire the corresponding document data from the document data management device of the web server on the basis of the identification information of the received document data;
a document data conversion device configured to read the corresponding conversion information from the conversion information management device on the basis of the received model type information of the mobile terminal, and to convert the acquired document data into the image data for browsing for the mobile terminal on the basis of the read conversion information; and
an image data transmitting device configured to transmit the converted image data for browsing to the mobile terminal.

5. The document browsing system according to claim 1,
wherein the document conversion server further comprises:
a document browsing application management device configured to manage a document browsing application with respect to each model type of the mobile terminal; and
a document browsing application transmitting device configured to read the corresponding document browsing application on the basis of the received model type information of the mobile terminal from the document browsing application management device, and to transmit the application to the mobile terminal, and
the image data transmitting device transmits the image data for browsing requested for browsing by the document browsing application, responsive to browsing operation at the mobile terminal having received the read document browsing application.

6. A document conversion server, comprising:
a conversion information management device configured to manage conversion information for converting document data into image data for browsing with respect to each model type of the mobile terminal;
a receiving device configured to receive the model type information of the mobile terminal and the document data from the web server;
a document data conversion device configured to read the corresponding conversion information from the conversion information management device on the basis of the received model type information of the mobile terminal, and to convert the received document data into the image data for browsing for the mobile terminal on the basis of the read conversion information; and
an image data transmitting device configured to transmit the converted image data for browsing to the mobile terminal.

7. A document conversion server, comprising:
a conversion information management device configured to manage conversion information for converting document data into image data for browsing with respect to each model type of the mobile terminal;
a document data conversion device configured to convert the document data into the image data for browsing for a mobile terminal, the image data for browsing corresponding to each mobile terminal, on the basis of the conversion information managed by the conversion information management device with respect to each model type of the mobile terminal;
an image data management device configured to manage the converted image data for browsing in association with the model type information of the mobile terminal and the identification information of the document data;
a receiving device configured, when the mobile terminal requests browsing of the document data managed by the web server, to receive the model type information of the mobile terminal and the identification information of the document data via the web server; and
an image data transmitting device configured to read the corresponding image data for browsing from the image data management device on the basis of the model type information of the mobile terminal and the identification information of the document data, having been received, and to transmit the read data to the mobile terminal.

8. A document conversion server, comprising:
a conversion information management device configured to manage conversion information for converting document data into image data for browsing with respect to each model type of a mobile terminal;
a receiving device configured, when the mobile terminal requests browsing of the document data managed by a web server via a predetermined web page, to receive the model type information of the mobile terminal, and to receive identification information of the document data having been requested for browsing;
a document data acquisition device configured to acquire the corresponding document data for browsing from the web server managing the document data, on the basis of the identification information of the received document data;
a document data conversion device configured to read the corresponding conversion information from the conversion information management device on the basis of the received model type information of the mobile terminal, and to convert the acquired document data into the image data for browsing for the mobile terminal on the basis of the read conversion information; and
an image data transmitting device configured to transmit the converted image data for browsing to the mobile terminal.

9. The document conversion server according to claim 6, further comprising:
a document browsing application management device configured to manage a document browsing application with respect to each model type of the mobile terminal; and
a document browsing application transmitting device configured to read the corresponding document browsing application from the document browsing application management device on the basis of the received model type information of the mobile terminal, and to transmit the application to the mobile terminal,
wherein the image data transmitting device transmits the image data for browsing requested for browsing by the document browsing application, responsive to browsing operation at the mobile terminal having received the document browsing application.
